(19) United States
(12) Patent Application Publication
(10) Pub. No.: US 2005/0231112 A1
(43) Pub. Date: Oct. 20, 2005

(54) Plasma display panel and method of manufacturing the same

(76) Inventors: Seok-Gyun Woo, Suwon-si (KR); Won-Ju Yi, Suwon-si (KR); Kyoung-Doo Kang, Suwon-si (KR)

Correspondence Address: Robert E. Bushnell, Suite 300, 1522 K Street, N.W., Washington, DC, 20005, US

(21) Appl. No.: 11/105,476

(22) Filed: Apr. 14, 2005

(30) Foreign Application Priority Data
Apr. 19, 2004 (KR) 10-2004-0026653

(51) Int. Cl. H01J 17/49

(52) U.S. Cl. 313/582

(57) ABSTRACT

A plasma display panel (PDP) and a method of manufacturing the same, where the PDP includes a front panel and a rear panel, which are disposed opposite to each other and bonded to each other. The front panel includes a front substrate, and the rear panel includes: a rear substrate disposed opposite to the front substrate; front barrier ribs, which are disposed on or above the rear substrate to define discharge cells and formed of a dielectric material; front discharge electrodes and rear discharge electrodes, which are disposed inside the front barrier ribs to surround the discharge cells and spaced apart from each other; and phosphor layers disposed in the discharge cells.

### CLAIM OF PRIORITY

This application makes reference to, incorporates the same herein, and claims all benefits accruing under 35 U.S.C. §119 from an application for A METHOD FOR MANUFACTURING A PLASMA DISPLAY PANEL earlier filed in the Korean Intellectual Property Office on 19 Apr. 2004 and there duly assigned Serial No. 10-2004-0026653.

### BACKGROUND OF THE INVENTION

1. Field of the Invention

The present invention relates to a plasma display panel (PDP) and a method of manufacturing the same, and more particularly, to a PDP with a new structure and a method of manufacturing the same.

2. Description of the Related Art

A device adopting a PDP has not only a large screen but also some excellent characteristics, such as high definition (HD), ultra-thin thickness, light weight, and wide view angle. Also, in comparison with other flat panel displays, the device including the PDP can be manufactured in a simple process and easily large-sized, so that it has attracted much attention as the next-generation flat panel device.

A conventional alternating current (AC) triode surface discharge type PDP includes a front panel and a rear panel. The front panel includes a front substrate, common electrodes, scan electrodes, a first dielectric layer, and a MgO protective layer. The common electrodes are disposed on a bottom surface of the front substrate, and the scan electrodes form discharge gaps with the common electrodes. The first dielectric layer is formed such that the common electrodes and the scan electrodes are buried. Also, the MgO protective layer is disposed on a bottom surface of the first dielectric layer.

The rear panel includes a rear substrate, address electrodes, a second dielectric layer, barrier ribs, and phosphor layers. The address electrodes are disposed on a top surface of the rear substrate to cross the common electrodes and the scan electrodes. The second dielectric layer is formed such that the address electrodes are buried. The barrier ribs are disposed on a top surface of the second dielectric layer and spaced a predetermined distance apart from each other such that discharge spaces are defined. The phosphor layers are disposed in the discharge spaces, which are filled with a discharge gas.

In the conventional PDP, a considerable amount (about 40%) of visible rays emitted from the phosphor layers are absorbed in the scan electrodes, the common electrodes, the dielectric layer covering the electrodes, and the MgO protective layer, which are disposed on the bottom surface of the front substrate. Thus, luminous efficiency is low. In particular, since discharge is not uniformly provoked in discharge cells, the luminous efficiency becomes lower. Further, when the conventional triode surface discharge type PDP displays the same image for a large amount of time, the phosphor layers are ion-sputtered due to charged particles of the discharge gas, thus causing permanent image sticking.

To manufacture this PDP, the front and rear panels are separately formed and then bonded to each other. Thereafter, the front and rear panels are sealed, and an exhaust gas and a discharge gas are injected therebetween. However, because the PDP has a very small pixel size, when the front and rear panels are separated formed and bonded to each other, it is highly likely that misalignments take place. Once the misalignments happen, the luminous efficiency of the PDP is degraded and misdischarge is generated. In addition, as the formation of the front and rear panels requires respective lines, the cost of equipment increases.

### SUMMARY OF THE INVENTION

It is therefore, an object of the present invention to provide a plasma display panel (PDP) with a new structure and a method of manufacturing the same.

It is another object of the present invention to provide a PDP that improves luminous efficiency while being driven at a low voltage.

It is yet another object of the present invention to a PDP where misalignments can be prevented during the assembling of the front and rear panels.

It is still another object of the present invention to provide a PDP that can prevent generation of misdischarge between the discharge cells.

It is another object of the present invention to provide a PDP that helps prevent an electrical short.

It is yet another object of the present invention to provide a PDP that prevents burn-in of an image in the plasma display panel.

According to an aspect of the present invention, there is provided a PDP including a front panel and a rear panel, which are disposed opposite to each other and bonded to each other. The front panel includes a front substrate, and the rear panel includes a rear substrate disposed opposite to the front substrate, front barrier ribs, which are disposed on or above the rear substrate to define discharge cells and formed of a dielectric material, front discharge electrodes and rear discharge electrodes, which are disposed inside the front barrier ribs to surround the discharge cells and spaced apart from each other, and phosphor layers disposed in the discharge cells.

According to another aspect of the present invention, there is provided a method of manufacturing a PDP including forming rear barrier ribs on or above a rear substrate; coating phosphor layers in spaces defined by the rear barrier ribs; forming front barrier ribs, inside which front discharge electrodes and rear discharge electrodes are disposed, on the rear barrier ribs, the front barrier ribs for defining discharge cells and formed of a dielectric material; and disposing a front substrate on or above the front barrier ribs.

The forming of the front barrier ribs may include forming first portions of the front barrier ribs on the rear barrier ribs; forming rear discharge electrodes on the first portions such that discharge cells are surrounded; forming second portions of the front barrier ribs on the first portions such that the rear discharge electrodes are buried; forming front discharge electrodes on the second portions such that the discharge cells are surrounded; and forming third portions of the front barrier ribs on the second portions such that the front discharge electrodes are buried.

In the PDP of the present invention, visible rays from the discharge cells are transmitted through the front substrate. Since there are no electrodes in portions of the front substrate that transmit the visible rays, the PDP has a high opening ratio and good transmissivity. Also, surface discharge can be induced from all the lateral surfaces of discharge spaces so that discharge surface can be greatly enlarged. Further, as discharge occurs from the lateral surfaces of the discharge cells and spread toward the centers of the discharge cells, a discharge region notably increases, thus enabling efficient utilization of the entire discharge cells. Accordingly, the PDP can be driven at a low voltage so that luminous efficiency is considerably enhanced. Also, even if a high-concentration Xe gas is used as a discharge gas, because the PDP can be driven at a low voltage, luminous efficiency is improved.

Furthermore, in the method of the present invention, a front panel and a rear panel can be manufactured in a single process line instead of separate lines. Therefore, the cost of production is reduced, and process time can be shortened. In addition, since front barrier ribs are directly formed on rear barrier ribs, misalignments can be prevented during the assembling of the front and rear panels.

### BRIEF DESCRIPTION OF THE DRAWINGS

A more complete appreciation of the invention, and many of the attendant advantages thereof, will be readily apparent as the same becomes better understood by reference to the following detailed description when considered in conjunction with the accompanying drawings in which like reference symbols indicate the same or similar components, wherein:

FIG. 1 is an exploded perspective view of a conventional plasma display panel (PDP);

FIG. 2 is an exploded perspective view of a PDP according to an exemplary embodiment of the present invention;

FIG. 3 is a cross-sectional view taken along lines III-III of FIG. 2;

FIG. 4 is a cross-sectional view taken along lines IV-IV of FIG. 3; and

FIGS. 5A through 5L are cross-sectional views illustrating a method of manufacturing the PDP shown in FIG. 2.

### DETAILED DESCRIPTION OF THE INVENTION

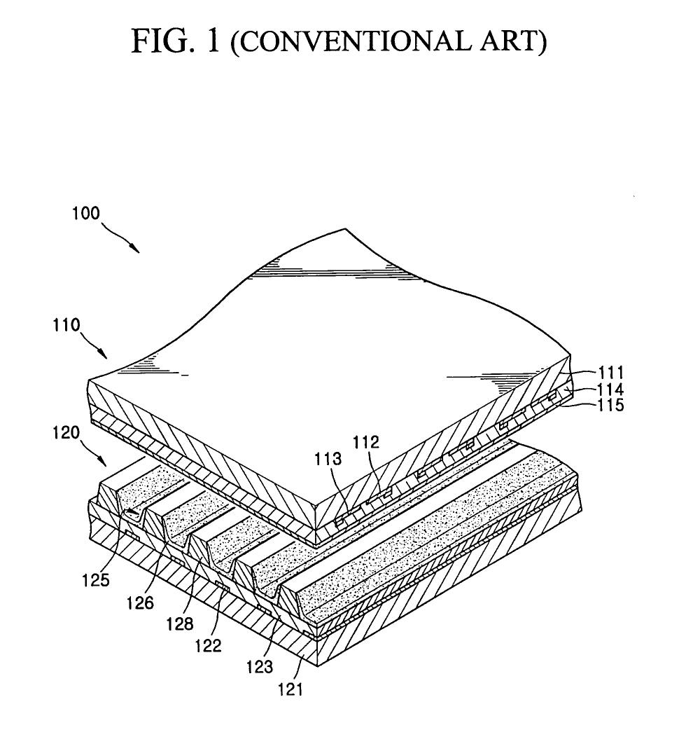

FIG. 1 is an exploded perspective view of a conventional alternating current (AC) triode surface discharge type PDP 100. The PDP 100 includes a front panel 110 and a rear panel 120. The front panel 110 includes a front substrate 111, common electrodes 112, scan electrodes 113, a first dielectric layer 114, and an MgO protective layer 115. The common electrodes 112 are disposed on a bottom surface of the front substrate 111, and the scan electrodes 113 form discharge gaps with the common electrodes 112. The first dielectric layer 114 is formed such that the common electrodes 112 and the scan electrodes 113 are buried. Also, the MgO protective layer 115 is disposed on a bottom surface of the first dielectric layer 114.

The rear panel 120 includes a rear substrate 121, address electrodes 122, a second dielectric layer 123, barrier ribs 128, and phosphor layers 126. The address electrodes 122 are disposed on a top surface of the rear substrate 121 to cross the common electrodes 112 and the scan electrodes 113. The second dielectric layer 123 is formed such that the address electrodes 122 are buried. The barrier ribs 128 are disposed on a top surface of the second dielectric layer 123 and spaced a predetermined distance apart from each other such that discharge spaces 125 are defined. The phosphor layers 126 are disposed in the discharge spaces 125, which are filled with a discharge gas (not shown).

In the conventional PDP shown in FIG. 1, a considerable amount (about 40%) of visible rays emitted from the phosphor layers 126 are absorbed in the scan electrodes 113, the common electrodes 112, the dielectric layer 114 covering the electrodes 112 and 113, and the MgO protective layer 115, which are disposed on the bottom surface of the front substrate 111. Thus, luminous efficiency is low. In particular, since discharge is not uniformly provoked in discharge cells, the luminous efficiency becomes lower. Further, when the conventional triode surface discharge type PDP 100 displays the same image for a large amount of time, the phosphor layers 126 are ion-sputtered due to charged particles of the discharge gas, thus causing permanent image sticking.

To manufacture this PDP 100, the front and rear panels 110 and 120 are separately formed and then bonded to each other. Thereafter, the front and rear panels 110 and 120 are sealed, and an exhaust gas and a discharge gas are injected therebetween. However, because the PDP 100 has a very small pixel size, when the front and rear panels 110 and 120 are separated formed and bonded to each other, it is highly likely that misalignments take place. Once the misalignments happen, the luminous efficiency of the PDP 100 is degraded and misdischarge is generated. In addition, as the formation of the front and rear panels 110 and 120 requires respective lines, the cost of equipment increases.

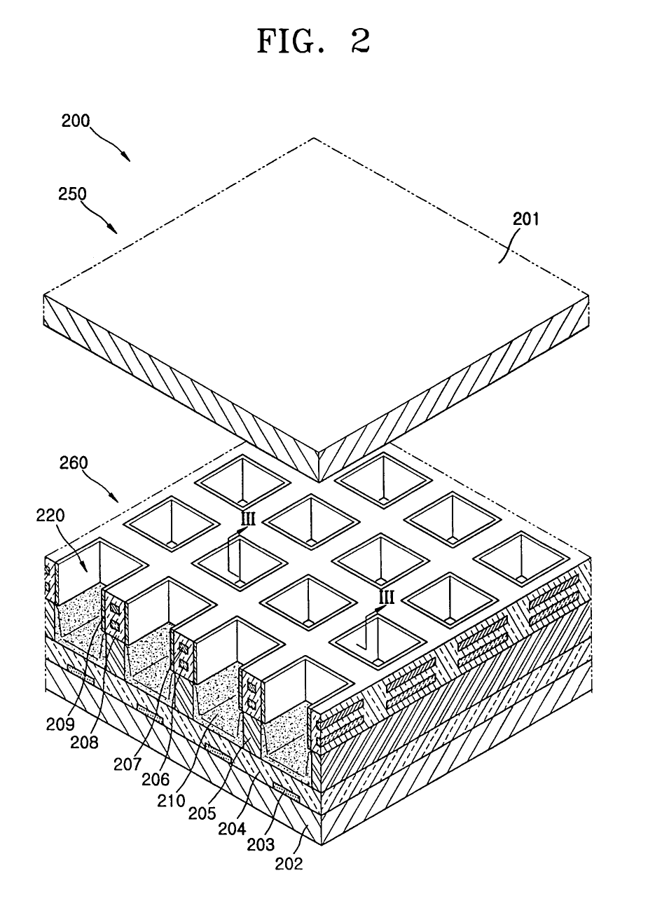

Referring to FIGS. 2 through 4, a plasma display panel (PDP) 200 according to an exemplary embodiment of the present invention includes a front panel 250 and a rear panel 260, which are disposed opposite to each other and can be bonded to each other. The front panel 250 includes a front substrate 201, while the rear panel 260 includes a rear substrate 202, front barrier ribs 208, front discharge electrodes 207, rear discharge electrodes 206, rear barrier ribs 205, address electrodes 203, a dielectric layer 204, a protective layer 209, and phosphor layers 210.

The rear substrate 202 is typically formed of glass and supports other components disposed thereon.

Along with the front and rear substrates 201 and 202, the front barrier ribs 208 disposed on or above the rear substrate 202 define discharge cells 220, each of which corresponds to one of red, green, and blue emitting sub-pixels that constitute one pixel. Also, the front barrier ribs 208 prevent generation of mis-discharge between the discharge cells 220. In the present invention, the front barrier ribs 208 have closed structures such that the discharge cells 220 are surrounded, and they are formed such that the discharge cells 220 have rectangular cross sections. Further, due to the front barrier ribs 208, the discharge cells 220 are arranged in a matrix shape.

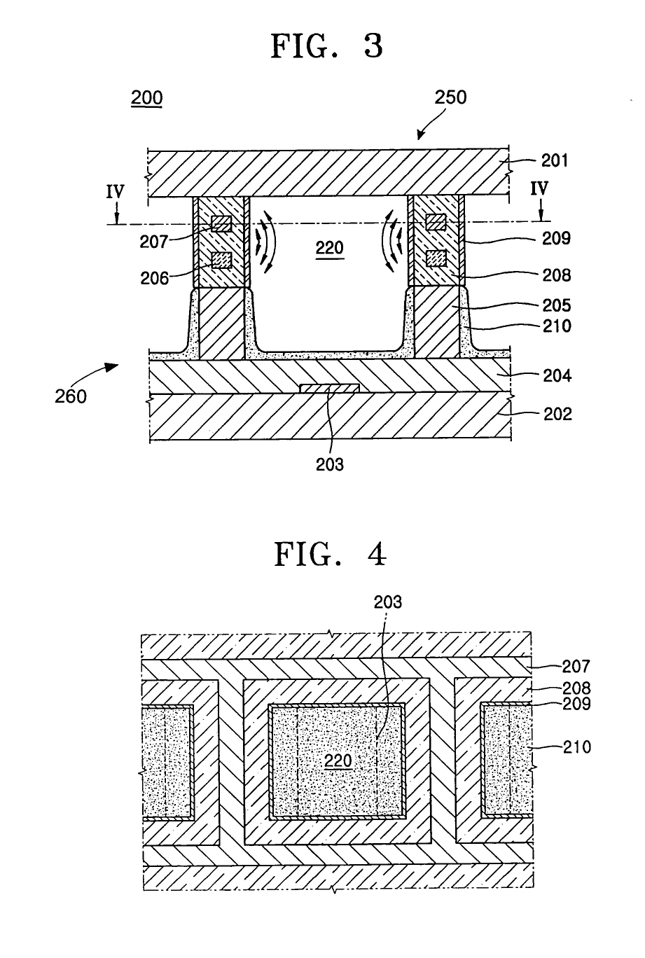

As shown in FIGS. 3 and 4, inside the front barrier ribs 208, the front discharge electrodes 207 and the rear discharge electrodes 206, which surround the discharge cells 220, are disposed apart from each other in a vertical direction to the front substrate 201 and extend parallel to each other along the discharge cells 220 arranged in a row. Since the front discharge electrodes 207 and the rear discharge electrodes 206 may be formed of a conductive material, such as Al or Cu, the likelihood of malfunctions due to a voltage drop is reduced.

The front barrier ribs 208 prevent the electrical short between the front discharge electrodes 207 and the rear discharge electrodes 206 and inhibit charged particles from directly colliding with the front and rear discharge electrodes 207 and 206 and damaging the same. The front barrier ribs 208 may be formed of a dielectric material, such as PbO, B₂O₃, or SiO₂, which can accumulate wall charges by inducing charged particles.

On the rear substrate 202 facing the front substrate 201, the address electrodes 203 extend in a direction to cross the direction in which the front and rear discharge electrodes 207 and 206 extend. Also, the address electrodes 203 extend parallel to each other across the discharge cells 220 arranged in a row.

The address electrodes 203 are used to generate address discharge, which facilitates sustain discharge between the front discharge electrodes 207 and the rear discharge electrodes 206. More specifically, the address electrodes 203 aid in lowering a voltage at which sustain discharge begins. Address discharge refers to discharge induced between a scan electrode and an address electrode. Once the address discharge ends, positive ions are accumulated in the scan electrode, and electrons are accumulated in a common electrode, thereby facilitating sustain discharge between the scan electrode and the common electrode.

Also, when a distance between a scan electrode and an address electrode is small, address discharge is efficiently provoked or produced. Accordingly, in the exemplary embodiment of the present invention, the rear discharge electrodes 206 act as scan electrodes because they are close to the address electrodes 203, while the front discharge electrodes 207 act as common electrodes.

The dielectric layer 204 is disposed such that the address electrodes 203 are buried or embedded. This dielectric layer 204 may be formed of a dielectric material, such as PbO, B₂O₃, or SiO₂, which prevents positive ions or electrons from colliding with and damaging the address electrodes 203 during discharge and also induces charges.

The rear barrier ribs 205 are disposed on the dielectric layer 204 so as to partition regions where the phosphor layers 210 are arranged. Although the rear barrier ribs 205 are partitioned in a matrix shape in FIG. 2, the present invention is not limited thereto. As long as it is possible to form a plurality of discharge spaces, the rear barrier ribs 205 may have a variety of patterns. For example, the rear barrier ribs 205 may have not only open patterns, such as stripes, but also closed patterns, such as waffles, matrixes, and deltas. Also, in addition to the rectangular cross sections as in the present embodiment, closed barrier ribs may be formed such that the cross sections of discharge spaces are polygonal (e.g., triangular or pentagonal), circular, or elliptical. In the present embodiment of the present invention, the front barrier ribs 208 and the rear barrier ribs 205 have the same shape, but may have different shapes. Further, the front barrier ribs 208 and the rear barrier ribs 205 may be formed as one body such that the front barrier ribs 208 and the rear barrier ribs 205 are hard or difficult to be separated from each other.

The phosphor layers 210 are arranged in spaces defined by the rear barrier ribs 205. More specifically, the phosphor layers 210 are disposed on the lateral surfaces of the rear barrier ribs 205 and on the dielectric layer 204. The phosphor layers 210 absorb ultraviolet rays, which are emitted due to discharge between the front discharge electrodes 207 and the rear discharge electrodes 206, and emit visible rays. In this case, the phosphor layers 210 contain elements that absorb ultraviolet rays and emit visible rays. Namely, phosphor layers in a red emitting sub-pixel contain a fluorescent material such as Y(V,P)O₄:Eu, phosphor layers in a green emitting sub-pixel contain a fluorescent material such as Zn₂SiO₄:Mn or YBO₃:Tb, and phosphor layers in a blue emitting sub-pixel contain a fluorescent material such as BAM:Eu.

At least the lateral surfaces of the front barrier ribs 208 may be covered by the protective layer 209, which is formed of MgO. The MgO layer 209 may be obtained using deposition methods and formed not only on the lateral surfaces of the front barrier ribs 208 but also on the lower lateral surfaces of the front barrier ribs 208 and the lower lateral surface of the front substrate 201 between the discharge cells 220. In this case, the MgO layer 209 is not an indispensable element. However, the MgO layer 209 prevents charged particles from colliding with and damaging the front barrier ribs 208 formed of a dielectric material and also, emits a plurality of secondary electrons during discharge.

In the present embodiment of the present invention, since the visible rays from the discharge cells 220 are transmitted through the front substrate 201 and then externally emitted, the front substrate 201 is formed of a material, such as glass, having good transmissivity. The front substrate 201 of the present invention has a very good forward transmissivity because it does not include scan electrodes, common electrodes, a first dielectric layer covering the scan electrodes and common electrodes, and a protective layer, unlike a front substrate of a conventional PDP. Therefore, if an image is embodied on the conventional level of luminance, the scan electrodes and the common electrodes are driven at a relatively low voltage so that luminous efficiency improves.

After the front and rear panels 250 and 260 are bonded using an encapsulant such as frit, a discharge gas, for example, Ne, Xe, or a mixture thereof, is injected into the discharge cells 220, and the discharge cells 220 are sealed. In the present invention, because discharge surface can increase and discharge regions can be enlarged, the amount of generated plasma increases, thus enabling a low-voltage drive of the PDP 200. Accordingly, even if a high-concentration Xe gas is used as a discharge gas, the PDP 200 can be driven at a low voltage so that luminous efficiency is greatly enhanced. This solves the problems of a conventional PDP, which cannot be driven at a low voltage when a high-concentration Xe gas is used as a discharge gas.

A method of driving the PDP having the above-described structure will be described now.

At the outset, by applying an address voltage between the address electrodes 203 and the rear discharge electrodes 206, address discharge is induced, with the result that one discharge cell 220 where sustain discharge will be generated is selected. Thereafter, if an alternating current (AC) sustain discharge voltage is applied between the front discharge electrode 207 and the rear discharge electrode 206 of the selected discharge cell 220, sustain discharge is induced between the front and rear discharge electrodes 207 and 206. As the energy level of a discharge gas excited by the sustain discharge is lowered, ultraviolet rays are emitted. Then, the ultraviolet rays excite the phosphor layer 210 coated inside the discharge cell 220. As the energy level of the excited phosphor layer 210 is lowered, visible rays are emitted. The emitted visible rays constitute an image.

In the conventional PDP 100 shown in FIG. 1, because sustain discharge is horizontally generated between the scan electrode 113 and the common electrode 112, discharge area is relatively narrow. On the other hand, in the PDP 200 of the present invention, sustain discharge is generated from all the lateral surfaces that define the discharge cell 220 and thus, discharge area is relatively wide.

Also, in the exemplary embodiment of the present invention, the sustain discharge is induced in the form of a closed curve along the lateral surfaces of the discharge cell 220 and then gradually spreads toward the center of the discharge cell 220. Thus, the volume of a region where the sustain discharge occurs is increased. Moreover, even space charges of the discharge cell 220, which are not conventionally utilized, contribute to luminescence. As a result, the luminous efficiency of the PDP 200 is enhanced.

Further, in the PDP 200 of the present invention, as shown in FIG. 3, sustain discharge is generated only in portions defined by the front barrier ribs 208. Accordingly, unlike in the conventional PDP 100, the ion-sputtering of the phosphor layers due to charged particles is prevented, so that even if the same image is displayed for a long time, no permanent image sticking or burn-in is caused.

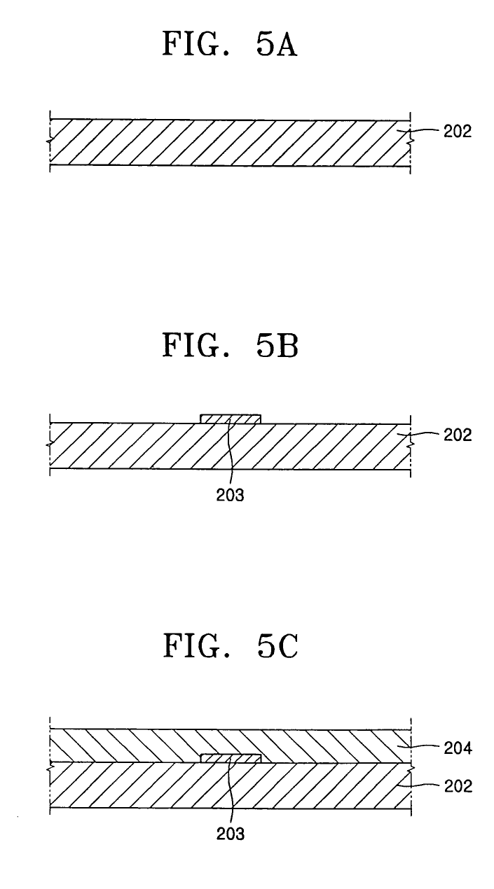

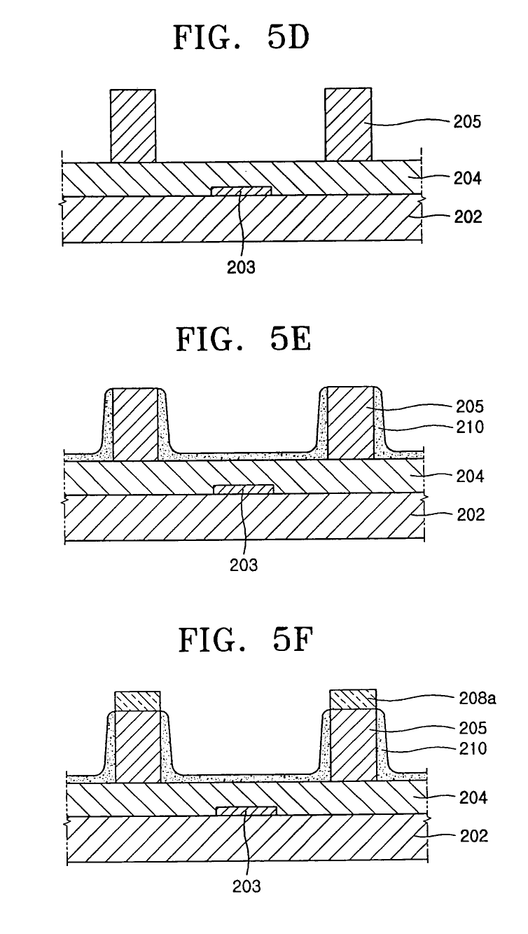

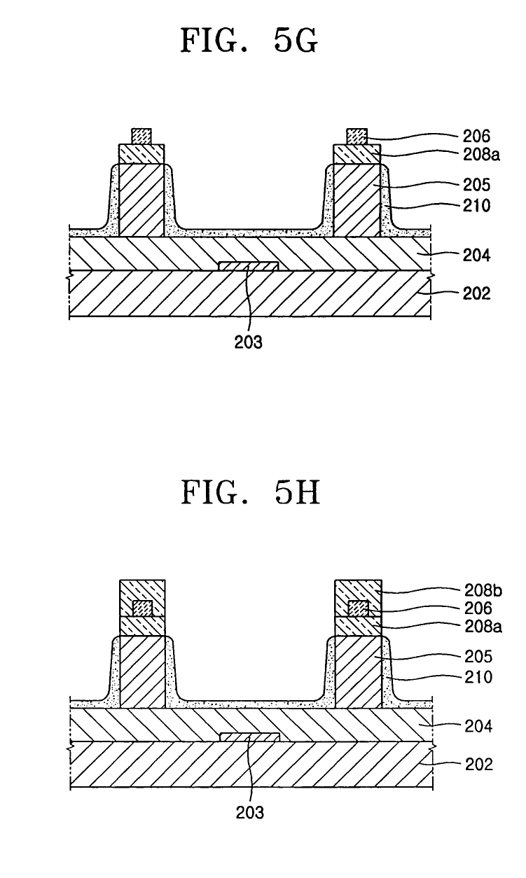

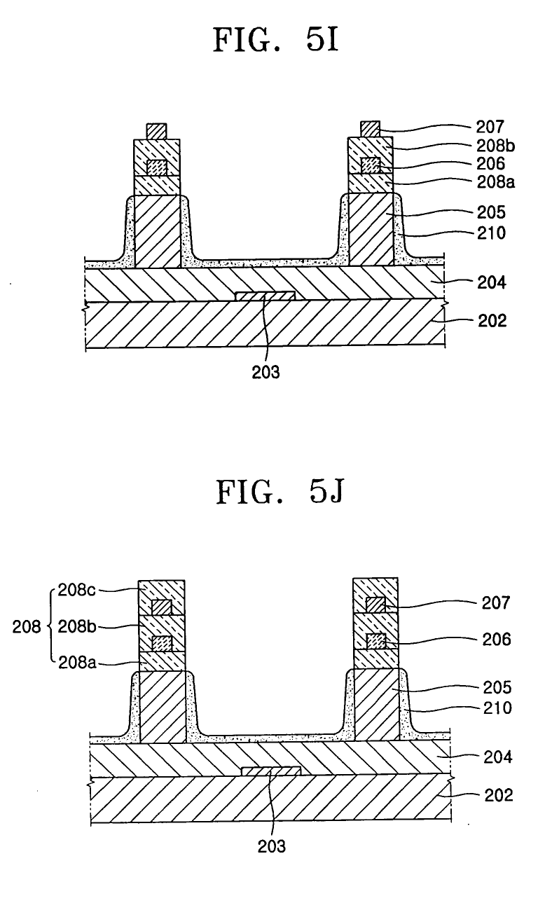

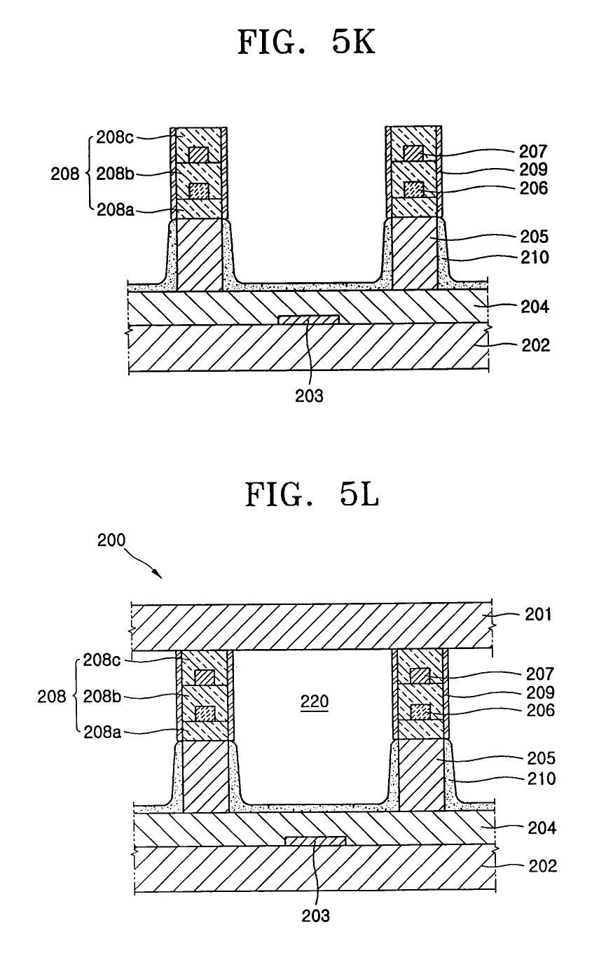

Hereinafter, a method of manufacturing the PDP 200 according to the exemplary embodiment of the present invention will be described with reference to FIGS. 5A through 5J.

Referring to FIGS. 5A and 5B, a rear substrate 202 is prepared, and address electrodes 203 are formed on the rear substrate 202 such that they extend in one direction and parallel to each other. In this case, the address electrodes 203 may be formed using a method, such as photoetching or printing.

Thereafter, as shown in FIG. 5C, a dielectric layer 204 is formed such that the address electrodes 203 are buried. The dielectric layer 204 may be formed using a method, such as printing or dryfilm.

In the method of manufacturing the PDP 200 according to the exemplary embodiment of the present invention, a process of forming the address electrodes 203 is illustrated, but the present invention is not limited thereto. If the PDP 200 is manufactured without the formation of the address electrodes 203, a process of forming the dielectric layer 204 may be omitted.

Referring to FIG. 5D, rear barrier ribs 205 are formed on the dielectric layer 204. The rear barrier ribs 205 define spaces in which the phosphor layers 210 are disposed. The rear barrier ribs 205 may be formed using a method, such as screen printing or sandblasting.

Referring to FIG. 5E, phosphor layers 210 are formed in spaces defined by the rear barrier ribs 205. The phosphor layers 210 are formed such that they form substantially planar top surfaces with the rear barrier ribs 205. The phosphor layers 210 may be obtained using a variety of methods, preferably, pattern printing, photosensitive paste, or dryfilm.

After the phosphor layers 210 are formed, front barrier ribs 208 are formed on the rear barrier ribs 205 as shown in FIGS. 5F through 5J. Specifically, first portions 208a of the front barrier ribs 208 are formed on the rear barrier ribs 205. The first portions 208a are formed such that the discharge cells 220 are partitioned in a matrix shape as shown in FIGS. 2 and 4, but the present invention is not limited thereto. In this process, the first portions 208a of the front barrier ribs 208 and the rear barrier ribs 205 may be formed as one body. The first portions 208a may be formed using a method, such as screen printing or sandblasting.

In the method of the present invention, a process of separately forming a front panel and a rear panel and aligning them is unnecessary because the front barrier ribs 208 are formed on the rear barrier ribs 205. Therefore, misalignments caused by an assembling process error are prevented during the assembling of the front and rear panels 250 and 260.

Thereafter, rear discharge electrodes 206 are formed on the first portions 208a such that the discharge cells 220 are surrounded or encompassed. The rear discharge electrodes 206 may be formed of a conductive material, such as Al or Cu, as described above and have the shape of a ladder as shown in FIG. 4. The rear discharge electrodes 206 may be formed using a method, such as photoetching, photosensitive paste, or printing paste.

Thereafter, second portions 208b of the front barrier ribs 208 are formed such that the rear discharge electrodes 206 are buried. Along with the first portions 208a, the second portions 208b are formed such that the discharge cells 220 are partitioned in the matrix shape. The second portions 208b of the front barrier ribs 208 may be formed using a method, such as screen printing or sandblasting.

Next, front discharge electrodes 207 are formed on the second portions 208b of the front barrier ribs 208. Like the rear discharge electrodes 206, the front discharge electrodes 207 may be formed of a conductive material, such as Al or Cu, and have the form of a ladder as shown in FIG. 4. Also, similarly to the rear discharge electrodes 206, the front discharge electrodes 207 may be formed using a method, such as photoetching, photosensitive paste, or printing paste.

In the method of the present invention, since the address electrodes 203 are formed, the front discharge electrodes 207 and the rear discharge electrodes 206 extend in one direction such that they are parallel to each other and cross the direction in which the address electrodes 203 extend. However, if the address electrodes 203 are not formed, the front discharge electrodes 207 and the rear discharge electrodes 206 are formed such that they extend to cross each other.

After the front discharge electrodes 207 are formed on the second portions 208b of the front barrier ribs 208, third portions 208c of the front barrier ribs 208 are formed such that the front discharge electrodes 207 are buried. Likewise, the third portions 208c partition the discharge cells 220 in a matrix shape along with the first portions 208a. The third portions 208c may be formed using a method, such as screen printing or sandblasting, like the first portions 208a.

The first, second, and third portions 208a, 208b, and 208c of the front barrier ribs 208 prevent the electrical short between the front discharge electrodes 207 and the rear discharge electrodes 206 during discharge and inhibit charged particles from colliding with and damaging the electrodes 206 and 207. Also, the first, second, and third portions 208a, 208b, and 208c may be formed of a dielectric material, such as PbO, B₂O₃, or SiO₂, which can accumulate wall charges by inducing charged particles. The front barrier ribs 208 comprise the first, second, and third portions 208a, 208b, and 208c.

After the front barrier ribs 208 and the rear barrier ribs 205 are formed, a protective layer is formed using MgO on the lateral surfaces of the front barrier ribs 208 as shown in FIG. 5K. The MgO protective layer 209 may be formed using a method such as sputtering.

Thereafter, as shown in FIG. 5L, a transparent front substrate 201 is disposed on the front barrier ribs 208 such that it is parallel to the rear substrate 202, and hermetically sealed.

As described above, after the front substrate 201 is disposed on or above the front barrier ribs 208 and sealed, a process of exhausting gases remaining in the discharge cells 220 and injecting a discharge gas into the discharge spaces may be further carried out.

The same reference numerals are used to denote the same elements throughout FIGS. 2 through 5L.

While the present invention has been particularly shown and described with reference to exemplary embodiments thereof, it will be understood by those of ordinary skill in the art that various changes in form and details may be made therein without departing from the spirit and scope of the present invention as defined by the following claims.

1. A plasma display panel, comprising:
a front panel and a rear panel, which are disposed opposite to each other and bonded to each other, said front panel comprises a front substrate, and said rear panel comprises:
a rear substrate disposed opposite to said front substrate;
front barrier ribs, which are disposed on or above said rear substrate to define discharge cells and formed of a dielectric material;
front discharge electrodes and rear discharge electrodes, which are disposed inside said front barrier ribs to surround the discharge cells and spaced apart from each other; and
phosphor layers disposed in the discharge cells.

2. The plasma display panel of claim 1, wherein said front discharge electrodes extend in a direction, and said rear discharge electrodes extend in a direction to cross the direction in which the front discharge electrodes extend.

3. The plasma display panel of claim 1, wherein said front discharge electrodes and said rear discharge electrodes extend in a direction to be parallel to each other,
further comprising address electrodes extending in a direction to cross the direction in which said front discharge electrodes and the rear discharge electrodes extend.

4. The plasma display panel of claim 3, wherein said address electrodes are disposed between said rear substrate and said phosphor layers.

5. The plasma display panel of claim 3, further comprising a dielectric layer disposed to cover said address electrodes.

6. The plasma display panel of claim 3, wherein said address electrodes are disposed on the rear substrate that is opposite to the front substrate.

7. The plasma display panel of claim 1, further comprising rear barrier ribs disposed between said front barrier ribs and said rear substrate.

8. The plasma display panel of claim 7, wherein said phosphor layers are disposed on at least the lateral surfaces of said rear barrier ribs.

9. The plasma display panel of claim 7, wherein said front barrier ribs and said rear barrier ribs are formed as one body.

10. The plasma display panel of claim 1, wherein at least the lateral surfaces of said front barrier ribs are covered by a protective layer.

11. A method of manufacturing a plasma display panel, the method comprising:
forming rear barrier ribs on or above a rear substrate;
coating phosphor layers in spaces defined by said rear barrier ribs;
forming front barrier ribs on said rear barrier ribs, said front discharge electrodes and said rear discharge electrodes are disposed inside said front barrier ribs, said front barrier ribs defining discharge cells and formed of a dielectric material; and
disposing a front substrate on or above said front barrier ribs.

12. The method of claim 11, wherein the forming of said front barrier ribs comprises:
forming first portions of said front barrier ribs on said rear barrier ribs;
forming rear discharge electrodes on said first portions to accommodate discharge cells being surrounded;
forming second portions of said front barrier ribs on said first portions to accommodate said rear discharge electrodes being buried;
forming front discharge electrodes on said second portions to accommodate the discharge cells being surrounded; and
forming third portions of said front barrier ribs on said second portions to accommodate said front discharge electrodes being buried.

13. The method of claim 11, wherein said front discharge electrodes extending in a direction to cross said rear discharge electrodes extending in another direction.

14. The method of claim 11, wherein said front discharge electrodes and said rear discharge electrodes extending in a direction parallel to each other.

15. The method of claim 14, further comprising forming a plurality of address electrodes between said phosphor layers and said rear substrate to accommodate said address electrodes extending in a direction to cross the direction said front discharge electrodes and the rear discharge electrodes extend.

16. The method of claim 15, further comprising forming a dielectric layer to cover. said address electrodes between said rear substrate and said phosphor layers.

17. The method of claim 11, further comprising forming a protective layer on at least one surface of each of said front barrier ribs.

18. The method of claim 17, wherein said protective layer is formed on the lateral surfaces of said front barrier ribs.

19. The method of claim 12, wherein said first portions of said front barrier ribs and said rear barrier ribs are formed as one body.

20. The method of claim 11, wherein each one of said front discharge electrodes and rear discharge electrodes is formed to have the shape of a ladder.

21. The plasma display panel of claim 7, with said front barrier ribs comprising:
a first portion of said front barrier ribs being formed on said rear barrier ribs, said rear discharge electrodes being disposed on said first portions to encompass the discharge cells, said first portion and said rear barrier ribs being formed as one body;
a second portion of said front barrier ribs being formed on said first portions to embed said rear discharge electrodes, said front discharge electrodes being formed on said second portions to encompass said discharge cells; and
a third portion of said front barrier ribs being disposed on said second portion to embed said front discharge electrodes.
